(19) United States
(12) Patent Application Publication
(10) Pub. No.: US 2001/0032675 A1
(43) Pub. Date: Oct. 25, 2001

(54) Bi-directional pressure relief valve

(76) Inventor: Keith M. Russell, Ivoryton, CT (US)

Correspondence Address: PHILIP J LEE, 10050 REGENCY CIRCLE, SUITE 525, OMAHA, NE, 68114

(21) Appl. No.: 09/791,149

(22) Filed: Feb. 22, 2001

Related U.S. Application Data
(60) Provisional application No. 60/185,274, filed on Feb. 28, 2000.

(51) Int. Cl. F16K 17/18

(52) U.S. Cl. 137/493.9

(57) ABSTRACT

A bidirectional flow control valve functions as a pressure relief valve as to flow in one axial direction and as a check valve as to flow in the other direction, comprising a generally cylindrical casing with a central axial bore in which a poppet having a central head and peripheral flow openings and a cylindrical valve seat member having a central flow passage and an annular valve seat are slidably restrained and spring biased toward each other to seal the valve by engagement of the poppet head and the valve seat, preventing axial flow, the poppet biasing spring exerting a greater force on the poppet than the force exerted on the valve seat member by the valve seat member biasing spring such that the valve serves as a relief valve which opens when fluid pressure on the poppet compresses the poppet biasing spring allowing displacement of the poppet head from he valve seat and as a check valve when fluid pressure on the valve seat member compresses the valve seat member biasing spring allowing displacement of the valve seat from the poppet head.

### CROSS REFERENCE TO RELATED PROVISIONAL APPLICATION

This application claims the benefit of U.S. Provisional Application No. 60/185274, filed Feb. 28, 2000.

### BACKGROUND OF THE INVENTION

A. Field of invention

The present invention relates generally to fluid control valves and more particularly, to a new and improved bidirectional pressure relief valve employed for regulation of pressure in hydraulic or pneumatic systems.

B. Description of Related art

Conventional pressure relief valves are used in various hydraulic or other fluid systems to limit the maximum pressure in either the system or for a particular component. In within a fluid system there may be subsystems or components with very different operating pressure ranges, for example, cooling radiators operating at 10-20 psig, lubrication systems operating at 50-100 psig, fuel systems operating at 300-1200 psid and hydraulic systems with 3000 to 5000 psid. The pressure relief valve protects the separate devices or subsystems from over pressurization by opening when fluid pressure in excess of a determined maximum amount causes the valve to open, allowing fluid to escape the over-pressurized portion of the system, which effectively reduces the pressure to the desired maximum. Limiting the pressure prevents damage or malfunction of the system or component. Common devices for such pressure relief valves comprise a ball or poppet forced against a valve seat by a spring or other biasing device of predetermined spring strength. At least a portion of the transverse surface of the ball or poppet is exposed to the pressurized fluid such that the fluid exerts a force in opposition to the spring. At cracking pressure, the force of the fluid exerted against the ball or poppet exceeds the force of the spring, the ball or poppet is displaced away from the valve seat and a passage is opened for the fluid to escape the pressurized system. When the pressure within the system returns to below the pressure required to hold the valve open (generally less than the cracking pressure), the force of the spring returns the ball or poppet to the valve seat closing the valve, thereby preventing additional fluid in the system from escape.

A type of flow control valve, commonly known as a check valve, performs the function of allowing flow in one desired direction only (herein called positive). Back flow is generally prevented by causing the valve to respond to a negative (reverse) pressure differential by closing the valve. Check valves frequently involve a valve seat and a moveable poppet or other member which is displaced from the valve seat by a positive pressure differential. Check valves may be relatively easily opened to flow in the desired direction, and typically present little resistance to flow in the desired direction. A common design feature of check valves is the presence of a spring or other biasing means which act to close the valve in the event of less than the desired minimum positive pressure and to assist and speed closing and sealing the valve in the event of negative pressure. Frequently the poppet of a check valve exposures a greater transverse area to negative pressure than to positive pressure such that the negative pressure acts to close the valve which may reduce the spring force needed to close the valve. Generally a reduction in the spring force will reduce the resistance to positive flow.

In both conventional check valves and pressure relief valves, there is ordinarily only a single possible flow direction through the valve. In a check valve the designed function is to prevent negative flow. In a relief valve prevention of negative flow is a common consequence of the design. The biasing of the poppet against the valve seat in the first, negative, direction, opposite from the designed relief flow, prevents flow in the second, relief flow, positive direction under less than cracking pressure and is otherwise sealed in the absence of relief flow, preventing flow in either direction. Pressure relief valves are not commonly designed to allow negative flow under any conditions. Any pressure in the negative direction opposite from the relief flow generally acts upon the spring side of the poppet or ball and increases the closing pressure further forcing the ball or poppet against the valve seat in addition to the spring force. The main purpose of the design of the pressure relief valve is to prevent positive flow except in the event of over pressurization, but preventing negative flow may be a consequence. On the other hand, the primary design purpose of a check valve is specifically to prevent negative flow while allowing positive flow. An example of a typical application of a check valve is a simple piston pump with inlet and outlet check valves. Withdrawal of the piston causes suction and one valve allows the free flow of fluid into a piston and when the piston direction changes, the first valve closes and the other valve opens, causing fluid to be pumped out.

The design of fluidic systems may require the use of both check and pressure relief valves. Such valves are sometimes used in parallel when it is necessary, for example to protect the system or a component thereof from excessive negative pressure restrained by a check valve. Parallel check relief valve arrangements are bulky in themselves and the required flow passages and connectors. The inconsistent features of check and relief valves prevent a simple back to back serial arrangement of in line valves since the negative flow of the relief valve (which is prevented) is the positive flow of the check valve, which is generally allowed. A need exists for a single valve which could combine the functions of the parallel relief check valve arrangement while providing for flow in either direction with flow in both directions restricted in variable degrees such that the device acts as a relief valve in one direction and a check valve in the opposite direction or as a relief or check valve in both directions, depending on the relative cracking pressures in the opposing directions. Providing these functions in a single, axial flow package would be a further benefit. A bidirectional relief valve that meets these conditions and is economic to manufacture, easy to install, useful in a wide range of applications would be desirable.

### SUMMARY OF THE INVENTION

The invention herein described is a new bidirectional axial flow control valve which generally comprises a poppet and a tubular valve seat member, each of which is spring biased in opposing directions within a generally cylindrical valve casing defining a central axial valve bore. The valve has a first end and a second end, the poppet generally toward the second end and the valve seat member generally toward the first end. The poppet has a generally cylindrical body section, the interior of which forms a flow passage and a valve head end which engages the valve seat member. The poppet is biased toward the valve seat member by a helical poppet biasing spring. The poppet biasing spring is compressed between a first spring stop member and an opposing poppet shoulder. The spring stop is generally annular with a central flow passage, and the poppet biasing spring surrounds the poppet body. A poppet restraint shoulder projects radially outward from the poppet and faces first end in the direction of the valve seat. The poppet shoulder is engageable with and opposed by a poppet stop shoulder, formed within the valve bore by an inward projection of the inner wall of the casing, facing the second end in the opposite direction away from the valve seat to restrain the travel of the poppet in the direction of the valve seat. The poppet end closest to the valve seat member forms a valve head, which faces and engages the tubular valve seat member also retained within the valve bore. A central flow passage extends through the poppet body and ends in four flow openings which allow fluid communication between the poppet flow passage and a chamber formed within the valve casing bore. The valve chamber is sealed from axial flow by the sealing engagement of the poppet head and the valve seat member.

The poppet flow openings are arranged radially around the portion of the poppet valve head which engages the valve seat member. Free fluid communication is provided by the poppet flow openings from the poppet side of the valve to the valve chamber on the poppet side of the poppet to valve seat contact.

The tubular valve seat member is biased toward the poppet valve head by a valve seat biasing spring. The interior of the valve seat member comprises a flow passage coaxial with the valve casing and the poppet. The valve seat member flow passage terminates at the poppet side in an annular valve seat edge. When the poppet valve head engages the valve seat edge, an annular seal is formed preventing flow through the valve. The valve seat biasing spring is compressed between a second generally annular spring stop member with a central flow passage and a spring engaging end of the valve seat member. Both spring stop members are secured within the valve casing. The outer surface of the valve seat member is a close but freely sliding fit within the valve bore and comprises circumferentially extending groove which retains an annular sealing ring preventing flow through between the inner wall of the valve bore and the outer surface of the valve seat member. An annular flat end surface of the valve seat member faces the poppet and is exposed to the pressure of the fluid in the valve chamber on the poppet side of the valve head to valve seat contact. The outer edge of the poppet facing end surface of the valve seat member is engageable with a inwardly projecting shoulder formed in the inner wall of the valve bore to restrain the travel of the valve seat member in the direction of the poppet.

The portion of the poppet valve head central to the engagement with the annular valve seat is exposed to the fluid from the valve seat side of the valve when the valve is closed. Both the poppet and the valve seat member are thus exposed to the pressure of fluid on the opposing sides of the valve, and in the absence of cracking pressure in either direction, the poppet valve head engages the valve seat and no flow is allowed through the valve at either direction. When the valve is closed and the poppet is in contact with the valve seat member, the shoulders restraining the poppet and the valve seat member are axially separated slightly less than the axial separation of the poppet shoulder and the poppet facing end surface of the valve seat member to avoid interference with a proper seating and seal betwen the poppet and the valve seat. When the fluid on the poppet side of the valve reaches the minimum cracking pressure in the check valve direction, the pressure of the fluid exerted against the exposed portion of the end surface of the valve seat member forces the valve seat member away from the poppet valve head. The poppet shoulder to poppet restraint shoulder contact prevents the poppet from moving with the valve seat, allowing the separation of poppet and valve seat member and flow is allowed through the valve from poppet side to valve seat side. Flow proceeds through the interior of the poppet spring stop, through the interior of the poppet from which it flows through the radial flow openings surrounding the poppet valve head and thence between the valve head and valve seat exiting the valve through the interior of the valve seat, the valve seat spring stop member and the valve casing. Flow in the opposite, relief, direction occurs in essentially the opposite manner with pressure on the valve seat side of the valve forces the poppet away from the valve seat. Flow in the relief direction does not occur until the valve seat member contacts and is stopped by the valve seat member restraint shoulder.

The second, valve seat biasing, spring is balanced against the first, poppet biasing, spring to achieve the desired flow characteristics. In the event a minimal cracking pressure is desired for a free flow direction, the second valve seat biasing spring can be relatively weak to allow the valve seat member to be displaced from the valve head at a relatively low cracking pressure. Flow in the opposite relief direction occurs when the fluid on the relief side of the poppet valve seat interface exceeds the relief cracking pressure sufficient to overcome the force of the first poppet biasing spring moving the poppet including the valve head in the relief flow direction. The poppet spring stop member may be adjustably secured within the valve casing bore by a threaded engagement with the interior wall of the valve bore. The degree of compression of the first, poppet biasing, spring is determined by adjustment of the spring stop by the rotation of a spring stop within the valve. Generally, the poppet biasing spring is stronger than the valve seat member biasing spring such that the valve functions as a check valve relative to flow from the poppet side and as a relief valve relative to flow from the valve seat side. However, the two springs could be of relatively equal strength such that the valve acts as a relief valve in both directions, or the valve seat biasing spring could be the stronger spring such that the valve functions as a check valve relative to flow from the valve seat side and as a relief valve relative to flow from the poppet side.

The valve casing is adapted to allow the valve to be secured within a fluid system and one manner of installing the valve within a bore involves the modification of an expansion end. The expansion end comprises a section of the valve casing wall having a grooved outer surface for engaging the inner wall of the installation bore and a tapered inner surface. A tapered expansion member has an outer surface with an outside diameter greater than the inside diameter of the inner surface of the valve casing expansion end and having a corresponding taper. The outer surface of the valve casing expansion end is controllably radially expanded when the expansion member is advanced into the expansion end due to difference between the outside diameter of the expansion member and the inside diameter of the expansion end. The forcible expansion of the expansion end causes the outer surface of the expansion end section of the valve casing to sealingly and frictionally engage the inner wall of the installation bore.

The principal aim of the present invention is to provide a new and improved pressure relief valve which meets the foregoing requirements and which is capable of controlling axial flow in both axial directions.

Another and further object and aim of the present invention is to provide a new and improved valve which can function as a pressure relief as to flow in one axial direction and as a check valve as to flow in the other axial direction.

Another and further object and aim of the present invention is to provide a bidirectional pressure relief valve with adjustable cracking pressure in at least one direction.

Other objects and advantages of the invention will become apparent from the Description of the Preferred Embodiments and the Drawings and will be in part pointed out in more detail hereinafter. The invention consists in the features of construction, combination of elements and arrangement of parts exemplified in the construction hereinafter described and the scope of the invention will be indicated in the appended claims.

### BRIEF DESCRIPTION OF THE DRAWINGS

FIG. 1 is an enlarged, longitudinal section view of a preferred embodiment of a valve constructed in accordance with the present invention, showing the valve closed to axial flow.

FIG. 2 is an enlarged, longitudinal section view of a preferred embodiment of a valve constructed in accordance with the present invention, showing the valve open to axial flow in a first direction.

FIG. 3 is an enlarged, longitudinal section view of a preferred embodiment of a valve constructed in accordance with the present invention, showing the valve open to axial flow in a second direction.

FIG. 4 is an enlarged, cross section view of a preferred embodiment of a valve constructed in accordance with the present invention, taken along line 4-4 shown in FIG. 3.

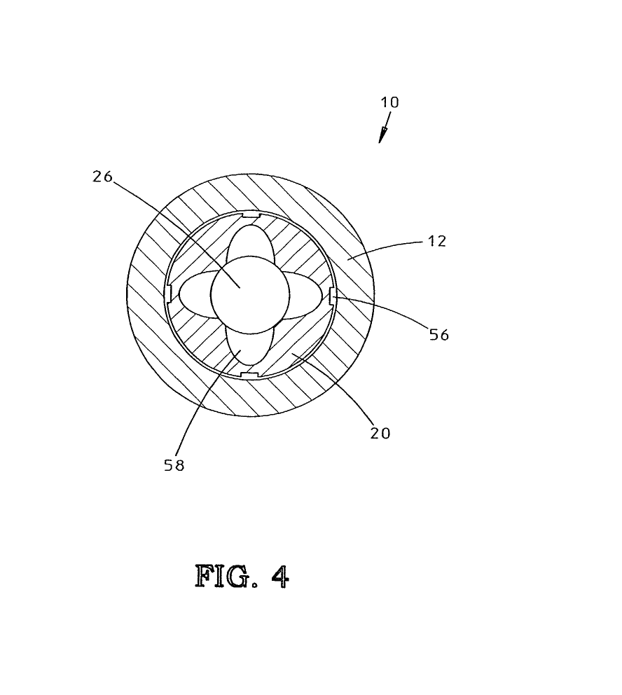

FIG. 5 is an enlarged, longitudinal section view of a second preferred embodiment of a valve constructed in accordance with the present invention, showing the valve closed to axial flow.

### DESCRIPTION OF THE PREFERRED EMBODIMENT(S)

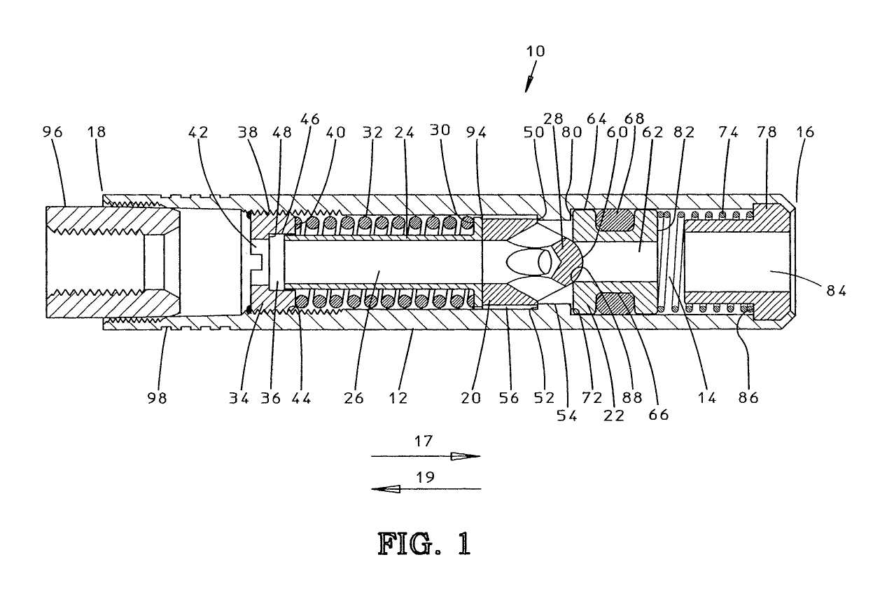

With reference to the Drawings wherein like numerals represent like parts throughout the Figures, a first preferred embodiment of a valve in accordance with the present invention is generally designated in FIG. 1 by the numeral 10. Valve 10 comprises a generally cylindrical valve casing 12 defining a central axial valve bore 14, casing 12 having a first end signified by the numeral 16 in FIG. 1 and a second end signified by the numeral 18 in FIG. 1. Further, the axial direction toward first end 16 is signified by the numeral 17 in FIG. 1 and the axial direction toward second end 18 is signified by the numeral 19 in FIG. 1 Casing 12 is designed to be inserted and fixed within a bore (not shown) and therefore comprises openings at both the first and second ends 16 and 18. It will be anticipated that casing 12 and its openings at either end may be readily modified for other types of connection to a fluidic system. A poppet 20 and a tubular valve seat member 22 engage each other and are contained within the valve bore 14 with the poppet 20 toward the second valve end 18 from the valve seat member 22. In the illustrated preferred embodiment, valve 10 functions generally as a check valve with respect to flow in the first direction 17 towards valve seat member 22 and as a pressure relief valve with respect to flow in second direction 19 towards poppet 20.

Poppet 20 has a generally cylindrical body section 24 and a valve head section 28 and is contained within the valve bore with the valve head section 28 toward the first valve end 16. In the preferred embodiment poppet body section 24 and poppet valve head section 28 are manufactured as separate pieces for economic reasons; however, poppet sections 24 and 28 are not designed to disengage or move relative to each other in the operation of valve 10. Therefore, poppet sections 24 and 28 could be formed as a single piece and for ease of discussion, reference herein relating to the poppet 20 assumes reference to both sections 24 and 28. Poppet body section 24 is rotationally symmetrical about the common axis of poppet 20 and valve 10 and poppet valve head section 28 is bilaterally symmetrical. The interior of poppet body section 24 forms an interior, axial, flow passage 26 and the exterior of poppet body section 24 is stepped with a portion of lesser outside diameter and a portion of outside diameter approximately the same as that of the poppet valve head section 28, the step forming an annular shoulder 30 facing second end 18. A radially protruding portion 94 of the outer surface of poppet 20 is formed in part by the increased diameter portion of poppet body section 24 and in part by poppet head section 28. A first, poppet biasing, helical spring 32 surrounds a portion of the reduced diameter portion of poppet body section 24 and is compressed between a first spring stop member 34 and opposing poppet shoulder 30.

Spring stop member 34 is generally annular, defining a central flow passage 36 and an threaded outer surface 38, and having a flat, annular spring stop end 40 and an slotted end 42. A portion of the poppet body section 24 is slidingly received within a section 46 of the spring stop flow passage 36 having of increased inner diameter forming an annular shoulder 48 facing toward the first end 16. The spring stop shoulder 48 prevents axial travel of the poppet 20 in the second axial direction 19 past the position of spring stop shoulder 48. The spring stop threaded surface 38 is engageable with inner screw threads 44 formed in the inner wall of valve casing 12, such that rotation of the first spring stop member 34 within valve casing 12 caused the controlled axial movement of the first spring stop member 34 which determines both the limit of axial travel of poppet 20 in the second axial direction 19 and the compression of first spring 32. Rotation of first spring stop member 34 within valve casing 12 is generally accomplished by engagement of spring stop slotted end 42 by a screw driver or similar device (not shown).

The increased diameter section 94 of poppet 20 which forms poppet shoulder 30 also forms a second poppet shoulder 50 which faces the first end 16 and is opposed by and engageable with a poppet restraining shoulder 52 formed by a reduced diameter section 54 of the inner wall of valve casing 12. Poppet section 94 is generally cylindrical and slidingly received within valve bore 14 to guide poppet 20 while allowing relatively free travel between the stopped positions. Four equiangularly placed grooves 56 extend axially the length of the outer surface of the raised portion of poppet head section 28. The engagement of second poppet shoulder 50 and poppet restraint shoulder 52 limits the travel of poppet 20 in first axial direction 17 and the engagement of the end of poppet body section 24 by spring stop shoulder 48 limits travel of poppet 20 in second axial direction 19. Central poppet flow passage 26 extends axially through the poppet body section 24 and ends in four flow openings 58 formed in poppet valve head section 28 which allow fluid communication between the central flow passage 26 and the valve casing bore 14. Poppet flow openings 58 are equidistally spaced around the perimeter of poppet valve head section 28, extending radially outward at an angle from the axis of poppet body flow passage 26. The surface of poppet valve head section 28 that faces and engages valve seat member 22 presents a valve seat engaging surface 60, similar in diameter to the poppet body flow passage 26. Flow openings 58 are located between poppet surface 60 and second poppet shoulder 50.

Valve seat member 22 is essentially tubular in shape defining a central flow passage 62 and a generally cylindrical outer surface 64 comprising a circumferentially extending groove 66 which retains an annular seal 68. Valve seat member 22 is symmetrical about a central axis and further comprises flat annular end surfaces 80 and 82 that are transverse to the common axis of valve 10 and valve seat member 22, valve seat end 80 being proximate to the poppet 20. Valve seat outer surface 64 and seal 68 are sized to be sealingly slidable within an area of increased inside diameter of valve bore 14 which extends axially between first valve end 16 and an annular, valve seat member restraint shoulder 72, which faces first valve end 16. The outer edge of valve seat member end surface 80, being of greater diameter than the inside diameter of restraint shoulder 72, impacts valve seat member restraint shoulder 72 to limit the travel of the valve seat member 22 in the second axial direction 19. Valve seat member 22 is biased in the second axial direction 19, toward the poppet 20 by a second, valve seat biasing spring 74. Valve seat flow passage 62 is coaxial with the valve casing 12 and poppet 20 and axially extends through the center of valve seat member 22. The valve seat biasing spring 74 is compressed between valve seat member end 82 and a second spring stop member 78 which also comprises a central flow passage 84 and a second spring engaging shoulder 86. In the illustrated preferred embodiment, second spring stop member 78 is secured within the valve casing 12 by crimping the first end 16 of valve casing 12, but other methods of securing the stop member 78 could be substituted, including adjustable means such as screw threads.

The edge of the opening of valve seat flow passage 62 in valve seat member end 80 comprises an annular valve seat edge 88 which is releasibly engageable with the surface 60 of poppet valve head section 28, and when valve seat edge 88 and poppet valve head surface 60 are sealingly engaged, flow of fluid through valve 10 is prevented. Poppet restraint shoulder 52 and valve seat member restraint shoulder 72 are spaced such that when valve seat edge 88 is in sealing contact with poppet valve head surface 60, the separation of poppet restraint shoulder 52 and valve seat member restraint shoulder 72 is slightly less than the axial separation of second poppet shoulder 50 and valve seat member end surface 80. Accordingly, a limited amount of axial movement of the poppet 20 and valve seat member 22 is possible without separation of the poppet 20 and valve seat member 22, specifically without separation of poppet surface 60 from valve seat edge 88.

When valve seat edge 88 is in sealing contact with poppet surface 60, and when valve seat member end 80 is in contact with valve seat restraint shoulder 72, so much of valve seat end surface 80 as is not covered by valve seat restraint shoulder 72 is exposed to the pressure of the fluid on the second end 18 side of the poppet surface 60 to valve seat edge 88 contact. When valve seat edge 88 is in sealing contact with poppet surface 60 and valve seat member end 80 is not in contact with valve seat restraint shoulder 72, all of valve seat end surface 80 as is not covered by valve seat restraint shoulder 72 is exposed to the pressure of the fluid on the second end 18 side of the poppet surface 60 to valve seat edge 88 contact When valve seat edge 88 is in sealing contact with poppet surface 60, so much of poppet surface 60 as is central to valve seat edge 88 is exposed to the pressure of the fluid on the first end 16 side of the poppet surface 60 to valve seat edge 88 contact.

Until the difference between the pressures on either side of the poppet surface 60 to valve seat edge 88 contact is sufficient to overcome the force of either the opposing first or second springs 32 or 74, the sealing engagement of poppet surface 60 to valve seat edge 88 seal will remain and the flow through valve 10 will not occur. The valve 10 in closed condition is shown in FIG. 1. As a consequence of the particular design of valve 10 to act as a relief valve as to flow in the second direction 19 and as a check valve as to flow in the first direction 17, poppet biasing spring 32 is stronger than valve seat member biasing spring 74. Therefore opening valve 10 to flow in the first axial direction 17 requires less fluid pressure than opening valve 10 to flow in the second axial direction 19. In the absence of fluid pressure, the valve 10 is at rest with poppet 20 restrained by shoulder 52. As an example only and not a limitation, in a valve 10 with a diameter of 0.28 inch, poppet biasing spring 32 may provide a preload force of 2.8 lbs and valve seat biasing spring 74 may provide a preload force of 0.5 lbs, whereby valve 10 would open to flow in the first direction 17 at 25 psid applied at second end 18 and open to flow in the second direction 19 at 1000 psid applied at first end 16. The degree of compression of the first, poppet biasing, spring 32 is determined by adjustment of the spring stop 34 by the rotation of spring stop 34 within the valve casing 12. The compression of valve seat biasing spring 74 could also be made adjustable by changing the means of fixing the axial position of spring stop 78, for example by a threaded engagement within casing 12.

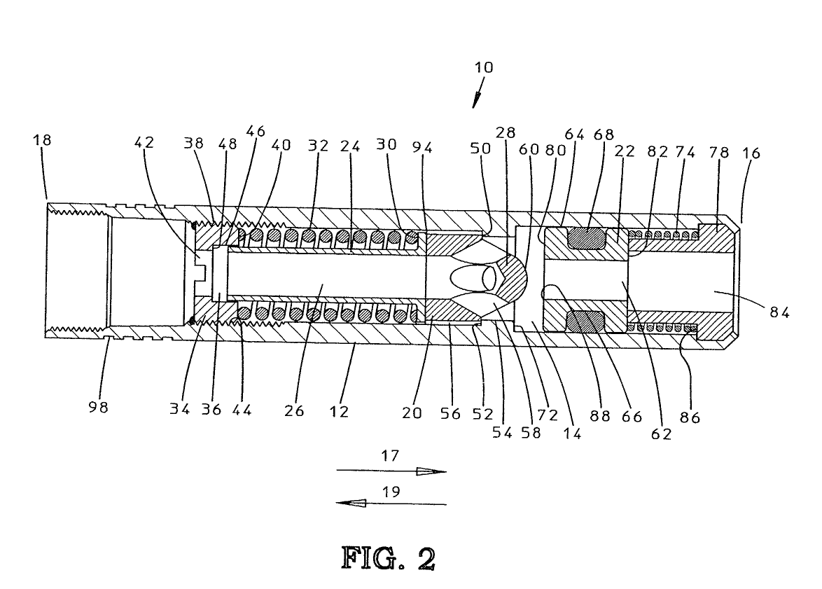

Upon application of sufficient fluid pressure to second valve end 18, the pressure acts through the flow path through poppet spring stop flow passage 36, thence through poppet flow passage 26, thence through poppet head flow openings 58, to exert fluid pressure on valve seat end 80. The force of fluid pressure on valve seat end 80 is transmitted through the valve seat member to compress spring 74, whereby valve seat member 22 is axially displaced from shoulder 72 in the first direction 17 until stopped by contact with second spring stop 78, as shown in FIG. 2, whereupon valve 10 is fully open to flow in the first direction 17.

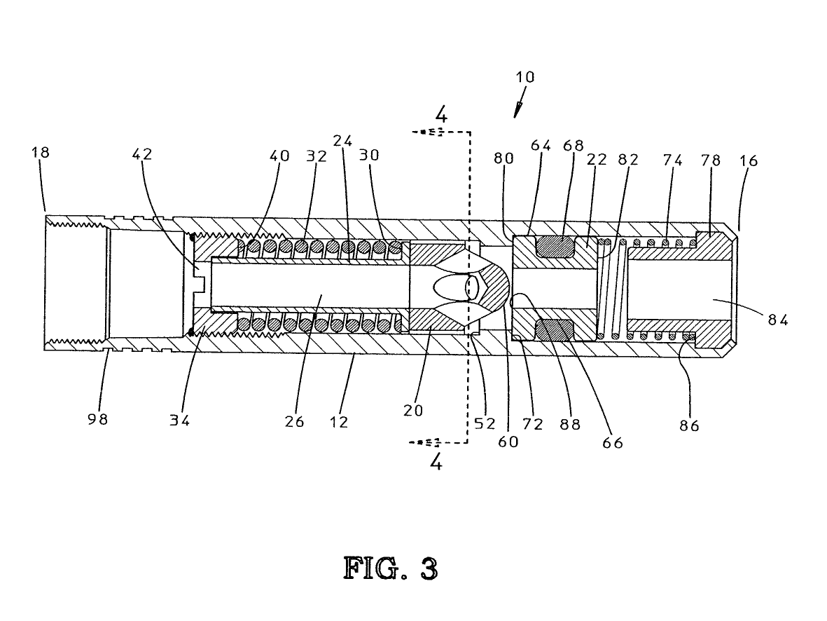

Upon application of sufficient fluid pressure to first valve end 16, the pressure acts through the flow passage 84 through second spring stop 78 upon valve seat member end 82, and also through the valve seat member flow passage 62, to exert fluid pressure on poppet head surface 60. Sufficient fluid pressure on valve seat end 82 and poppet head surface 60 acts to compress poppet biasing spring 32, whereby poppet 20 and valve seat member 22 are axially displaced in the second direction 19. After the movement of valve seat member 22 is stopped by contact with valve seat member restraint shoulder 72, further displacement of poppet 20 will open valve 10 to flow in the second direction 19. Once valve 10 opens to flow, the entire surface of poppet head section 28 and, via grooves 56, a portion of poppet body section 24 are exposed to fluid pressure. The fluid pressure acting on poppet 20, if sufficient, may further displace poppet 20 in the second direction 19 until poppet 20 is stopped by contact with spring stop shoulder 48, whereupon valve 10 is fully open to flow in the second direction 19, as shown in FIG. 3.

A section of outer surface of valve casing 12 at second end 18 comprises a series of circumferentially extending grooves 98 for engaging the inner wall of the installation bore (not shown). A tapered expansion member 96 has an tapered outer surface with an outside diameter greater than the inside diameter of the inner surface of the valve casing 12 at second end 18, which has a corresponding taper. The grooved outer surface of the valve casing 12 is controllably radially expanded when the expansion member 96 is advanced into the second casing end 18 due to difference between the outside diameter of the expansion member 96 and the inside diameter of the casing 12. The forcible expansion of the valve casing 12 causes the outer surface of the valve casing 12 to sealingly and frictionally engage the inner wall of the installation bore. Other possible means for connecting and securing valve 10 exist and are known, the preferred means being only one example. As a further examples, the valve ends 16 and 18 could be adapted for tubular connections to a fluid system, or the valve bore 14 could be formed in a manifold or similar fashion without departing from the scope of the present invention.

It will be anticipated that the functional characteristics of valve 10 can readily be changed by modifying the physical properties, specifically including but not only the spring force, of the valve seat biasing spring 74 and/or of the poppet biasing spring 32 as well as the preload compression of said springs. Valves 10 and 100 could be made to still function as a check valve as to flow in the first direction 17 with the valve seat biasing spring 74 being omitted or replaced by other biasing means. Similarly, it will be anticipated that the placement and use of the annular valve seat member seal 68 as shown herein is only an example of a useful design and seal 68 could be omitted or placed elsewhere without preventing the valve from functioning. Further, modifications of surface area exposed to fluid pressure can be made to alter the functioning of valve 10 to achieve desired flow characteristics. It will be further understood that the specific shapes and configuration of the illustrated poppet and valve seat represents an example only of one of many possible configurations. The illustrated, semi-spherical poppet head and annular edge valve seat of valve 10 represent a commonly useful design, however, other designs are known to exist and may be useful if incorporated into valve 10. Such variation of design would not be beyond the scope of the present invention.

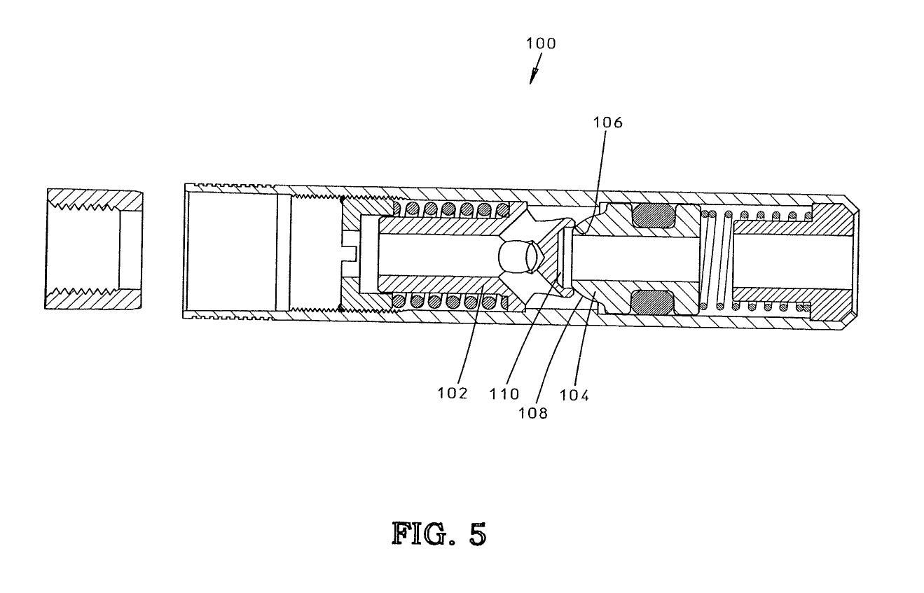

Poppet valve head surface 60 is illustrated in the drawings as a semi-spherical surface, but it will be anticipated that surface 60 could be formed in other useful shapes. In particular, surface 60 may be formed in a conical shape or other shape. In addition, as is illustrated by the second embodiment of a valve in accord with the present invention designated by numeral 100 in FIG. 5, other arrangements and shapes of poppet surfaces and valve seats are possible. Valve 100 employs a poppet 102 having a recess 110 in the head section which presents an edge 106 which engages and seats on the outer surface 108 of the valve seat member 104. Valve 100 is shown aas an example of other poppet head and valve seat configurations and not as a limitation of the scope of the invention. Still other configurations may be found to be in known designs which may be beneficially incorporated into the design of a valve without departing from the scope of the present invention.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

I claim:

1. A flow control valve comprising a generally cylindrical valve casing two openings for fluid communication to a fluidic system and defining an axial bore therebetween, a poppet and a valve seat member, the poppet and the valve seat member each being serially retained within the casing bore, axially movable therein and engageable with each other to prevent flow through the valve, the valve seat member being closer than the poppet to a first of the two casing openings and the poppet being closer than the valve seat member to a second of the two casing openings.

2. The flow control valve of claim 1, wherein the valve seat member is responsive to fluid pressure from the second casing opening to separate from the poppet to allow flow through the valve and the poppet is responsive to fluid pressure from the first casing opening to separate from the valve seat member to allow flow through the valve.

3. The flow control valve of claim 2, further comprising a poppet biasing spring compressed between the poppet and the end of the valve adjacent to the second casing opening to bias the poppet in the direction of the valve seat member and a valve member biasing spring compressed between the valve seat member and the end of the valve adjacent to the first casing opening to bias the valve seat member in the direction of the poppet.

4. The flow control valve of claim 3, wherein the poppet is exposed to fluid pressure from the first valve opening and the poppet biasing spring is compressible in response to said fluid pressure, when sufficient to exceed the force of the poppet biasing spring, to cause the poppet to separate from the valve seat member to allow axial flow through the valve, and wherein the valve seat member is exposed to fluid pressure from the second valve opening and the valve seat member biasing spring is compressible in response to said fluid pressure, when sufficient to exceed the force of the valve seat member biasing spring, to cause the valve seat member to separate from the poppet to allow axial flow through the valve.

5. The flow control valve of claim 4, wherein the poppet defines a flow passage in fluid communication with the second casing opening, and the valve seat member defines a central bore in fluid communication with the first casing opening.

6. The flow control valve of claim 5 wherein the poppet comprises a head section and the valve seat member comprises an annular valve seat surrounding the valve seat member bore, with which the poppet head section is releasibly engageable to prevent flow through the valve.

7. The flow control valve of claim 6, further comprising a poppet restraint shoulder formed within the valve bore by an inward projection of the inner wall of the casing, facing the second valve opening to restrain the displacement of the poppet in the direction of the valve seat member and a valve seat restraint shoulder formed within the valve bore by an inward projection of the inner wall of the casing, facing the first valve opening to restrain the displacement of the valve seat member in the direction of the poppet.

8. The flow control valve of claim 7, wherein the poppet further comprises a body section defining a central flow passage and a plurality of flow openings arranged radially around the poppet head section to allow flow past the poppet when the poppet head section is not seated against the valve seat.

9. The flow control valve of claim 8, wherein the valve seat member is generally cylindrical and the valve further comprises a seal extending circumferentially around the valve seat member preventing flow past the exterior of the valve seat member.

10. The flow control valve of claim 9, wherein the poppet and valve seat member are generally coaxial with the casing bore.

11. The flow control valve of claim 10, wherein the spring force of the poppet biasing spring is greater than the spring force of the valve seat member biasing spring.

12. The flow control valve of claim 11, wherein the poppet head section comprises a semispherical surface which contacts the annular valve seat.

13. The flow control valve of claim 12, further comprising means for securing the valve within, and connecting the first and second casing openings to, a fluidic system.

14. A flow control valve comprising a generally cylindrical valve casing two openings for fluid communication to a fluidic system and defining an axial bore therebetween, a poppet and a valve seat member, the poppet and the valve seat member each being serially and coaxially retained within the casing bore, axially movable therein and engageable with each other to prevent flow through the valve, the valve seat member being closer than the poppet to a first of the two casing openings and the poppet being closer than the valve seat member to a second of the two casing openings and the valve seat member is exposed to fluid pressure from the second casing opening and capable of response thereto by separating from the poppet to allow flow through the valve and the poppet is exposed to fluid pressure from the first casing opening and capable of response thereto by separating from the valve seat member to allow flow through the valve.

15. The flow control valve of claim 14, wherein the valve seat member is generally cylindrical and defines a central bore in fluid communication with the first casing opening and further comprises an annular valve seat formed at one end of the central bore, and wherein the poppet defines a flow passage in fluid communication with the second casing opening and further comprises a head section engageable with the valve seat member to prevent flow through the valve.

16. The flow control valve of claim 15, wherein the poppet further comprises a body section defining a central flow passage and a plurality of flow openings arranged radially around the poppet head section to allow flow past the poppet when the poppet head section is not seated against the valve seat.

17. The flow control valve of claim 16, further comprising means for securing the valve within, and connecting the first and second casing openings to, a fluidic system.

18. The flow control valve of claim 17, further comprising a poppet biasing spring compressed between the poppet and the end of the valve adjacent to the second casing opening to bias the poppet in the direction of the valve seat member and further compressible in response to fluid pressure from the first casing opening, to cause the poppet to separate from the valve seat member, and a valve member biasing spring compressed between the valve seat member and the end of the valve adjacent to the first casing opening to bias the valve seat member in the direction of the poppet and further compressible in response to said fluid pressure from the second casing opening to cause the valve seat member to separate from the poppet, the spring force of the poppet biasing spring being greater than the spring force of the valve seat member biasing spring.

19. The flow control valve of claim 18, further comprising a poppet restraint shoulder formed within the valve bore by an inward projection of the inner wall of the casing, facing the second valve opening to restrain the displacement of the poppet in the direction of the valve seat member and a valve seat restraint shoulder formed within the valve bore by an inward projection of the inner wall of the casing, facing the first valve opening to restrain the displacement of the valve seat member in the direction of the poppet.

20. The flow control valve of claim 19, further comprising a seal extending circumferentially around the valve seat member preventing flow past the exterior of the valve seat member and wherein the poppet head section comprises a semispherical surface which contacts the annular valve seat.
